(19) United States
(12) Patent Application Publication
(10) Pub. No.: US 2023/0162245 A1
(43) Pub. Date: May 25, 2023

(54) INVENTORY ITEM NORMALIZATION SYSTEM

(71) Applicant: Capital One Services, LLC, McLean, VA (US)

(72) Inventor: Walker Ramirez, Frisco, TX (US)

(21) Appl. No.: 17/535,208

(22) Filed: Nov. 24, 2021

(51) Int. Cl. G06Q 30/02; G06Q 10/08

(52) U.S. Cl. CPC G06Q 30/0283; G06Q 10/087

(57) ABSTRACT

An inventory normalization system is provided. The system may normalize and vectorize features associated with a preferred item to be purchased by a user. The normalized and vectorized features may be used with one or more user-defined importance weightings to identify, using various machine learning techniques, items similar to the preferred item. Vendors having in inventory the preferred item or one or more of the similar items may be identified. An online auction may be opened and the vendors may be requested to submit offers for the preferred item or one or more of the similar items. Received offer prices may be normalized, based on the importance weightings, to discount for missing features or unwanted features. The normalized offer prices may be compared and a best offer identified. The system may initiate purchase of the item corresponding to the selected offer.

### CROSS-REFERENCE TO RELATED APPLICATIONS

This application is related to U.S. patent application Ser. No. 17/104,684, filed on Nov. 25, 2020, the content of which is incorporated herein by reference in its entirety.

### FIELD OF USE

Aspects of the disclosure relate generally to methods of normalizing pricing of inventory items similar to a preferred or target item.

### BACKGROUND

When a consumer is interested in purchasing a commonly or widely available standard item, it may be fairly straightforward for the consumer to determine the best price being offered for the item. The consumer simply needs to compare the prices offered for identical items from different vendors to find the best price for that item. However, when a user's desired item is not widely available and/or the consumer is unable to find the desired item in inventory or when the user simply wants a more cost-effective alternative to the preferred item, the consumer may consider purchasing an item similar to the originally desired item. In such cases, the consumer will want to ensure that the similar item, at the very least, includes the features or attributes that the consumer found important in the originally desired item. Identifying such similar items can present its share of challenges, and then determining a fair and appropriate price for such items, particularly as compared to the price the consumer may have been willing to pay for the item they really desired, may present an even bigger challenge. No longer does the consumer have the ability to do a straightforward, apples-to-apples comparison between the prices of the different items, because the items themselves are not the same. The items may be similar to the originally desired item in ways that matter most to the consumer, but may be different in ways that an apples-to-apples comparison of pricing is not possible. Accordingly, there is a need for identifying items relevantly similar to a consumer's preferred item, in ways that are meaningful to the user (which may vary from one user to another), and comparing the pricing of such items to each other and to pricing for the consumer's preferred item.

### SUMMARY

The following presents a simplified summary in order to provide a basic understanding of various aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the detailed description below.

A user may identify a desired or preferred item that the user wishes to purchase. The item might be a vehicle, an appliance, an electronic device, or the like. For instance, the user may identify the item using identifying information, such as a brand and model number; may upload a photo of the preferred item; may provide a website having a picture or descriptive information of a preferred object; or may provide a link to a user-generated build of the preferred item, such as for a user's build of a preferred vehicle on a manufacturer's website. Features or attributes associated with the preferred item may be determined. For instance, if the preferred item is a 2022 BMW X5, determined features may include heated seats, XDRIVE, 4-doors, power steering, or the like. The features, in some cases, may be obtained by accessing a database including features of various items or may be obtained by performing web-scraping on a website associated with the preferred item. The determined features may be normalized. Normalizing the features may refer to converting an identification of such features to, instead, reflect the corresponding generic names for the features. For instance, the feature “XDRIVE” for the 2022 BMW X5 might be normalized to a more generic term, such as “all-wheel drive” or “AWD.” Based on the normalized features, a vectorized list of features may also be generated for the preferred items to create a uniform dataset of features. The vectorized list of features may be a list of all possible features associated with a given type of item, such as a vehicle, and may provide indications of which of the possible features are included in the particular item. The vectorized list of features may be used in comparing the features of similar items to one another. For instance, a user's preferred item may be the 2022 BMW X5, but the user's preferred item may not be available within proximity to the user or the user may be unable to afford the preferred item. In such cases, the user may be interested in finding other items that are similar to the user's preferred item—e.g., items with similar features. However, some features may be more important to the user than others, and the user may want any similarity analysis to take into account those features that are important to the user so that any identified similar items are relevant to what the user wants and needs. Accordingly, items that are relevantly similar to the user's preferred item may be identified and located. To identify and locate the relevantly similar items, items that are of the same type as the user's preferred item and that are in inventory at a vendor within a predetermined geographical area or predetermined geographical range of the user are identified. Vectorized lists of features for the items in inventory are compared with the vectorized list of features for the preferred item and the items in inventory are scored based on the presence or lack of presence of features important to the user. One or more machine learning techniques may be used, such as by applying a clustering algorithm (e.g., a K-means clustering algorithm) to a data set comprising data points representing the preferred item and the similar items, to identify those items that are the most similar. After the most similar items are identified, an online auction may be opened, and the vendors corresponding to the identified most similar items may be requested to make offers to the user for the sale of one or more of those items. Normalized pricing may be generated for the offered items. The normalized prices may be calculated to account or discount for important features that may be missing in an offered item. In some cases, the normalized prices may additionally discount for unwanted features that may be included in an offered item. In some cases, pricing may also be normalized to adjust for a distance of the vendor location from the user. The pricing for the offered items may be compared to the normalized pricing. For instance, if all-wheel drive is missing in one of the offered items, and all-wheel drive was identified as an important feature to the user, the normalized price may reflect a discount to the price by an amount specified by the user and that reflects, not necessarily the market value of the missing feature, but a value of that missing feature to the user. The offers may be presented to the user and a best offer recommended, taking into account any discounting. The user may select an offer and a purchase process between the user and the vendor may be initiated and/or facilitated.

These and other features and advantages of the disclosure will be apparent from the detailed description provided below.

### BRIEF DESCRIPTION OF THE DRAWINGS

Some features are shown by way of example, and not by limitation, in the accompanying drawings. In the drawings, like numerals reference similar elements.

FIG. 1 is a diagram of an example computing environment for an inventory normalization system, in accordance with one or more aspects described herein.

FIG. 2 is a diagram of an example hardware configuration of an example computing device used in an inventory normalization system, in accordance with one or more aspects described herein.

FIGS. 3A, 3B, 3C, 3D, 3E, and 3F show an example event sequence for performing inventory normalization functions, in accordance with one or more aspects described herein.

### DETAILED DESCRIPTION

In the following description of the various embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

Aspects discussed herein may relate to methods, systems, devices, and computer-readable media for an inventory normalization system.

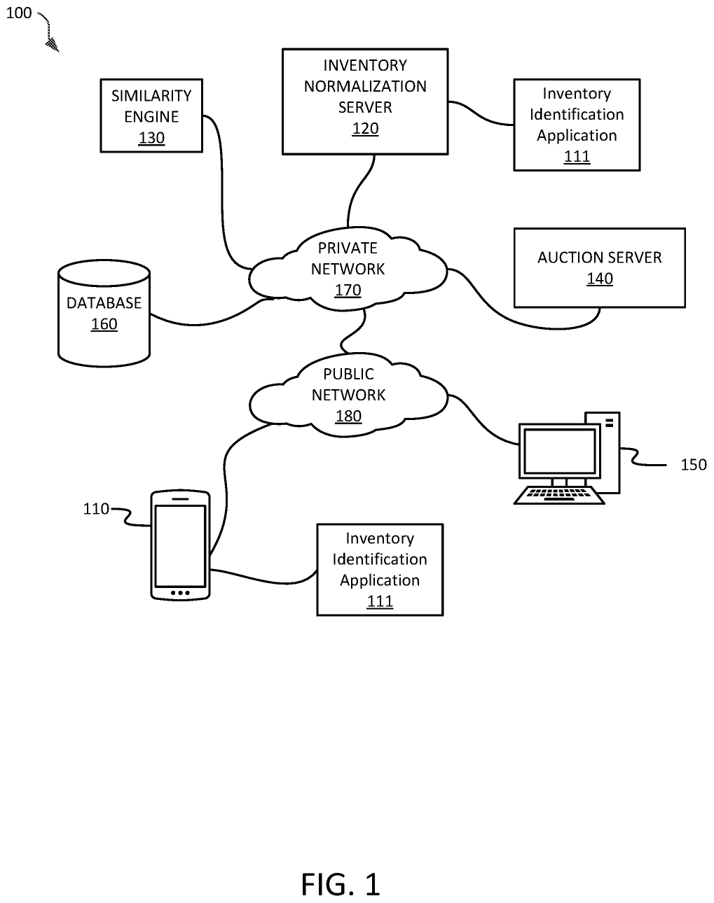

Referring to FIG. 1, an example computing environment for an inventory normalization system is provided. An inventory normalization system 100 may include one or more systems or computing devices, such as a user computing device 110, an inventory normalization server 120, a similarity engine 130, an auction server 140, one or more vendor computing devices 150, a database 160, a private network 170, and a public network 180. Although the various systems and computing devices in the inventory normalization system 100 are shown and described as separate devices, one or more of the systems/computing devices may be part of a single system/computing device without departing from the scope of the disclosure.

The user computing device 110 may be configured to communicate with and/or connect to one or more computing devices of the inventory normalization system 100 via the public network 180. In some instances, the user computing device 110 may have installed thereon one or more applications for performing one or more aspects described herein. For instance, the user computing device 110 may have installed thereon an inventory identification application 111, for use by a user in performing one or more functions of the inventory normalization system 100. In this case, the user computing device 110 may communicate with the inventory normalization server 120 via the inventory identification application 111. In some instances, the user computing device 110 may access a website hosted by and/or an application installed on the inventory normalization server 120 for performing one or more aspects described herein. For instance, the user computing device 110 may access, using a website and via the public network 180, the inventory identification application 111 installed at the inventory normalization server 120. In some instances, the inventory normalization server 120 may be embodied in the user computing device 110.

In some instances, the user computing device 110 may have integrated therein an image capturing device for capturing an image. For instance, the image capturing device may be one of one or more sensors of the user computing device 110, and one or more applications, such as a camera application, installed on the user computing device 110 may cause the image capturing device to be activated and to capture an image. The captured image may be stored on the user computing device 110 and/or on a different device. In some instances, the user computing device 110 may use an image capturing device that is separately embodied from the user computing device 110. For instance, when separately embodied, the image capturing device may, in some cases, be communicatively connected to the user computing device 110 and may be controlled by the user computing device 110. In some cases, when separately embodied, the image capturing device might not be connected to the user computing device 110 and, instead, may be communicatively connected to the public network 180 and configured to transmit images to the user computing device 110, the inventory normalization server 120, the similarity engine 130, the database 160, and/or to other devices via the public network 180.

The user computing device 110 may be any type of computing device or combination of devices capable of performing the particular functions disclosed herein. For example, the user computing device 110 may be and/or include server computers, desktop computers, laptop computers, tablet computers, smart phones, fitness devices, or the like that may include one or more processors, memories, communication interfaces, storage devices, and/or other components. The user computing device 110, in some instances, may be or include special-purpose computing devices configured to perform the functions disclosed herein. In some instances, some or all of the functionality of the inventory normalization server 120 may instead be performed by the user computing device 110 alone or in combination with the inventory normalization server 120.

The inventory identification application 111 may be an application associated with a user, such as a consumer interested in purchasing a particular item—such as a vehicle, an appliance, an electronic device, or the like. As will be described in further detail below, the inventory identification application 111 may be used to perform various functions associated with the inventory normalization system 100—such as receiving information related to a preferred or target item, identifying one or more vendors having the target item and/or similar items in inventory, receiving, from the one or more identified vendors, offer prices for the target item and/or similar items in inventory, and normalizing prices for the offered item based on information indicating user-identified utility or importance for one or more features, characteristics or attributes related to the preferred item. The inventory identification application 111 may generate and display one of more user interfaces to facilitate these functions. The inventory identification application 111 may be a server-based application installed and executed at the inventory normalization server 120. The server-based inventory identification application 111 may be accessed, through a website hosted by the inventory normalization server 120, using a client device, such as the user computing device 110. Additionally or alternatively, the inventory identification application 111 may be a client-based application installed and executed on a client device, such as the user computing device 110.

The inventory normalization server 120 may be a computing device, such as a server, used to provide functionality associated with determining a preferred or target item for purchase by a user, identifying one or more vendors having the target item and/or similar items in inventory, hosting a virtual auction between the identified one or more vendors, receiving, from the one or more identified vendors and via the auction, offer prices or bids for the target item and/or similar items in inventory, normalizing the prices for the offered items based on information indicating user-identified utility or importance for one or more features, characteristics or attributes related to the preferred item, recommending, to the user, a particular offer or indicating a winning offer/bid, and facilitating/initiating the purchase of an item between the user and a vendor. The user may access the inventory normalization server 120 through the inventory identification application 111 via a website hosted by the inventory normalization server 120. Alternatively or additionally, the user may access the inventory normalization server 120 via the inventory identification application 111 installed on the user computing device 110. In this case, the inventory identification application 111 may be communicatively connected to the inventory normalization server 120 via the public network 180 and/or the private network 170.

The similarity engine 130 may be a computing device used to identify items similar to a preferred or target item. The similarity engine 130 may receive a request from the inventory normalization server 120 to identify the similar items. The similarity engine 130 may use artificial intelligence, including neural networks and/or machine learning models and/or algorithms to identify the similar items. For instance, the similarity engine 130 may use machine learning models and/or algorithms, such as, but not limited to, supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. The similarity engine 130 may input to the machine learning model or algorithm a target item and/or attributes, characteristics, and/or features of the target item. The machine learning model or algorithm may be trained to identify one or more items having a similarity to the input target item based on the attributes, characteristics, and/or features of the items. The similarity engine 130 may output one or more similar items identified by the machine learning model or algorithm. The similarity engine 130 may be communicatively connected to the inventory normalization server 120 via the private network 170.

The auction server 140 may be a computing device, such as a server, used to provide functionality associated with hosting an online auction. While most transactions that a consumer initiates do not involve haggling and/or negotiation, such negotiation may arise during the course of large transactions (e.g., purchasing a home or vehicle) or even in certain venues (e.g., a farmer's market or flea market). In such instances, where a seller anticipates bargaining, the seller may advertise a higher price (e.g., a manufacturer's suggested retail price (MSRP)) with the expectation that, during negotiation, the buyer and the seller will arrive at a lower, mutually agreeable price. The range of possible prices in which a transaction may be mutually agreeable must be below the buyer's willingness to pay (e.g., the most the buyer can afford or the most the buyer perceives a good or service to be worth) and above the seller's marginal willingness to sell (the seller's actual value for a good or service below which they would perceive any transaction to be a “loss”). Within this range, the extent to which a transaction is more beneficial to one party depends on both external factors (e.g., supply constraints, consumer demand, economic outlook etc.) and internal ones—namely, the party's ability to negotiate. The values placed on a good or service by a seller and buyer are often and deliberately unknown to each other in order to prevent information asymmetries that may advantage one party over the other. For example, in an auto-buying transaction, the seller may advertise a vehicle at its MSRP. However, the seller's true value for the vehicle may be the invoice cost plus any fees or the value of any services provided by the seller in association with selling the vehicle. Price haggling or negotiation may allow the buyer to purchase the vehicle for an amount closer to the seller's true value. However, even when buyers do negotiate, they often walk away from a transaction wondering if they could have purchased the vehicle for less. This may cause buyers to distrust sellers out of fear of being taken advantage of. Indeed, if the buyer knew the seller's actual value for their goods or services, the buyer would be able to determine the quality of an offered deal. One such economic mechanism to uncover a party's true value for a good or service is through auctions, in which the seller's utility maximizing bid is equal to their actual value. While most auctions entail one or more parties bidding for one good, aspects described herein provide for a process by which multiple sellers may submit (e.g., bid or present) an offer to a buyer for one or more items that the seller may have in inventory and that match or are similar to an item which the buyer wishes to purchase. According, the auction server 140 may host an online auction between one or more vendors, in which the one or more vendors may compete for the user's business by making offers to sell the user an inventory item matching the user's preferred or target item and/or one or more similar items. The auction server 140 may provide one or more user interfaces where vendors may confirm the availability of one or more items identified for inclusion in the auction. In some cases, the vendor may be able to override the identified item and identify a different item for inclusion in the auction. Once the vendor confirms the one or items the one or more user interfaces may provide an option for a bid or offer price to be set. The auction server 140 may initiate or open the auction upon receiving a request from the inventory normalization server 120. The auction server 140 may be communicatively connected to the inventory normalization server 120 via the private network 170.

The one or more vendor computing devices 150 may be computing devices associated with vendors, such as vendors who sell vehicles, electronic devices, appliances, or the like. The one or more vendor computing devices 150 may be configured to communicate with and/or connect, via the public network 180, to one or more computing devices of the inventory normalization system 100. In some instances, the one or more vendor computing devices 150 may have installed thereon one or more applications for performing one or more aspects described herein. For instance, the one or more vendor computing devices 150 may store an application, such as an application for accessing an online auction.

The database 160 may store information used by the user computing device 110, inventory normalization server 120, the similarity engine 130, the auction server 140, or the one or more vendor computing devices 150. The database 160 may comprise one or more of a relational database, a hierarchical database, a distributed database, an in-memory database, a flat file database, an XML database, a NoSQL database, a graph database, or the like.

The private network 170 may be a network operated by, and internal to, an organization or business hosting the inventory normalization server 120. The private network 170 may be used to interconnect one or more computing devices internal to the organization or business. The private network 170 may further connect to the public network 180. The private network 170 may include one or more of local area networks (LANs), wide area networks (WANs), virtual private networks (VPNs), or the like.

The public network 180 may connect the private network 170, and/or the one or more computing devices connected thereto, to one or more networks, systems, and/or computing devices that might not be associated with the organization, such as the user computing device 110 or the one or more vendor computing devices 150. The public network 180 may include one or more networks, such as the Internet.

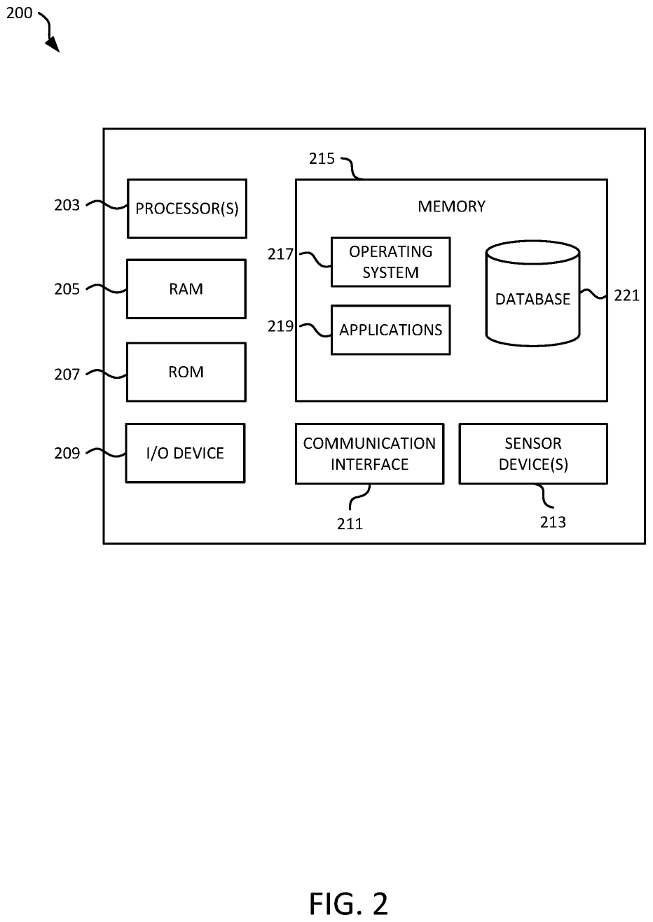

Referring to FIG. 2, an example hardware configuration of an example computing device 200 is provided. The example computing device 200 may include or incorporate any one of the user computing device 110, the inventory normalization server 120, the similarity engine 130, an auction server 140, or the one or more vendor computing devices 150. In some instances, the computing device 200 may represent, be incorporated in, and/or include various devices such as a desktop computer, a computer server, a mobile device, such as a laptop computer, a tablet computer, a smart phone, or any other types of mobile computing devices, and/or any other type of data processing device.

The computing device 200 may include one or more components, such as one or more processors 203, a random access memory (RAM) 205, a read-only memory (ROM) 207, an input/output (I/O) device 209, a communication interface 211, one or more sensor devices 213, and a memory 215. The computing device 200 may include one or more additional or different components.

The one or more processors 203 may be configured to control overall operation of the computing device 200 and its associated components. A data bus (not shown) may interconnect the one or more processors 203, the RAM 205, the ROM 207, the memory 215, the I/O device 209, the communication interface 211, and/or the one or more sensor devices 211. The one or more processors 203 may include a single central processing unit (CPU), which may be a single-core or multi-core processor, or may include multiple CPUs. The one or more processors 203 and associated components may control the computing device 200 to execute a series of computer-readable instructions to perform some or all of the processes disclosed herein. Although not shown in FIG. 2, various elements within the memory 215 or other components in the computing device 200, may include one or more caches, for example, CPU caches used by the one or more processors 203, page caches used by operating system 217, disk caches of a hard drive, and/or database caches used to cache content from database 221. For embodiments including a CPU cache, the CPU cache may be used by the one or more processors 203 to reduce memory latency and access time. The one or more processors 203 may retrieve data from or write data to the CPU cache rather than reading/writing to the memory 215, which may improve the speed of these operations. In some examples, a database cache may be created in which certain data from the database 221 may be cached in a separate smaller database in a memory separate from the database 221, such as in the RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

The I/O device 209 may include, but need not be limited to, a microphone, keypad, touch screen, and/or stylus, through which a user of the computing device 200 may provide input, and may also include one or more of a speaker for providing audio output, and a video display device for providing textual, audiovisual, and/or graphical output.

The communication interface 211 may include one or more transceivers, digital signal processors, and/or additional circuitry and software for communicating via a network (e.g., the private network 170, the public network 180, or the like), wired or wireless, using any protocol as described herein.

The one or more sensor devices 213 may include one or more of an accelerometer, a gyroscope, a GPS device, a biometric sensor, a proximity sensor, an image capturing device, a magnetometer, etc.

The memory 215 may store software to provide instructions to the one or more processors 203 allowing the computing device 200 to perform various actions. For example, the memory 215 may store software used by the computing device 200, such as the operating system 217, applications 219, and/or the database 221. The various hardware memory units in the memory 215 may include volatile and nonvolatile, removable and non-removable media implemented in any method or technology for storage of information, such as computer-readable instructions, data structures, program modules, or other data. The memory 215 may include one or more physical persistent memory devices and/or one or more non-persistent memory devices. The memory 215 may include, but need not be limited to, the RAM 205, the ROM 207, electronically erasable programmable read only memory (EEPROM), flash memory, or other memory technology, optical disk storage, magnetic cassettes, magnetic tape, magnetic disk storage or other magnetic storage devices, or any other medium that may be used to store the desired information and that may be accessed by the one or more processors 203.

Although various components of the computing device 200 are described separately, functionality of the various components may be combined and/or performed by a single component and/or multiple computing devices in communication without departing from the scope of the disclosure.

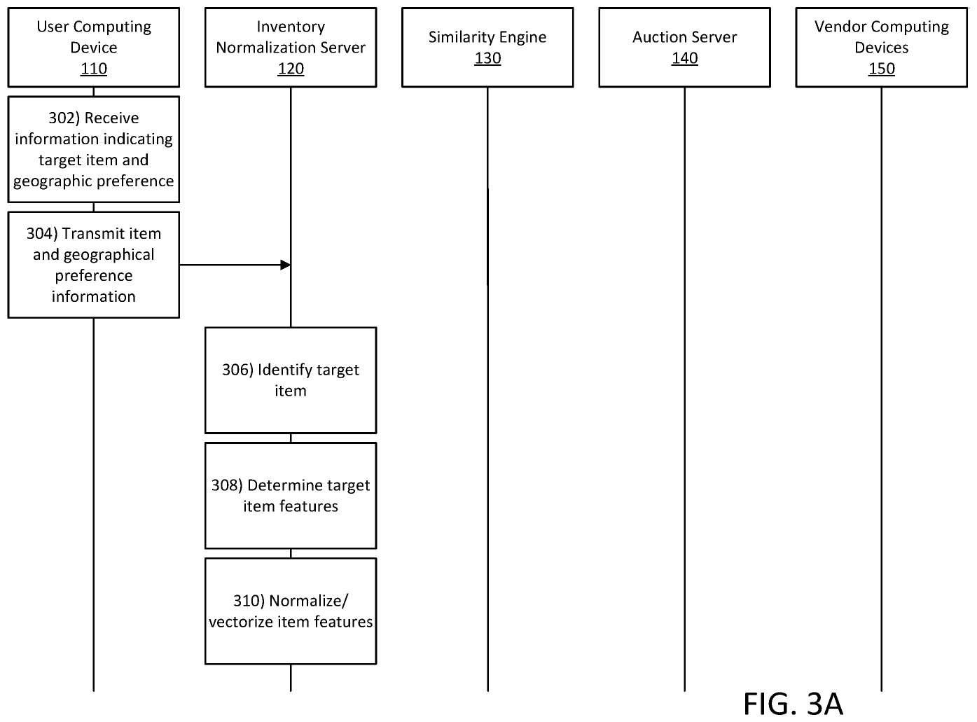

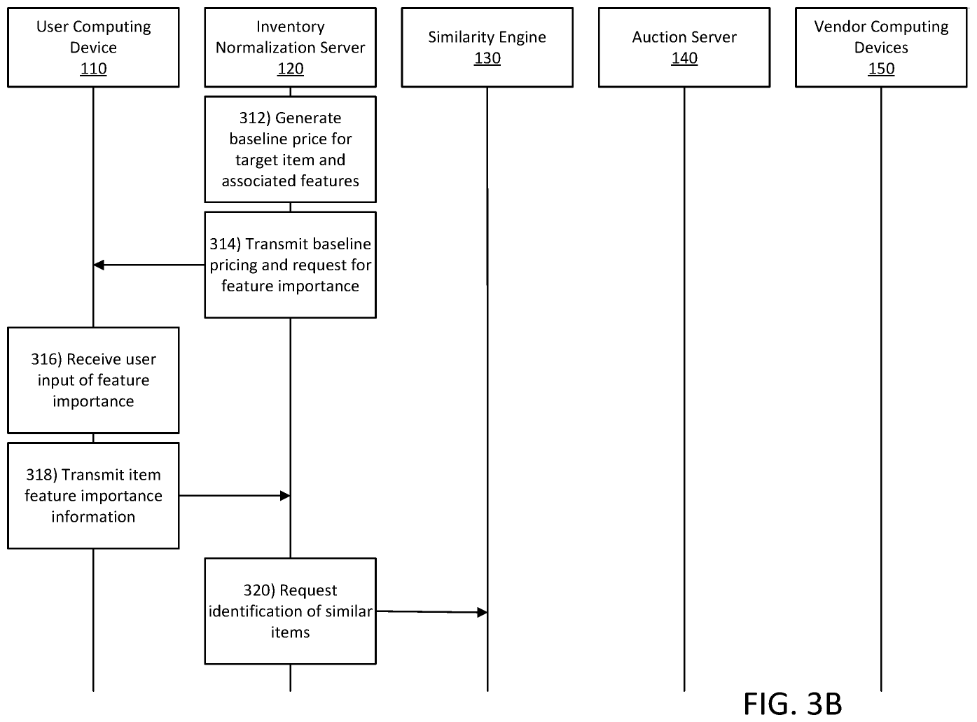

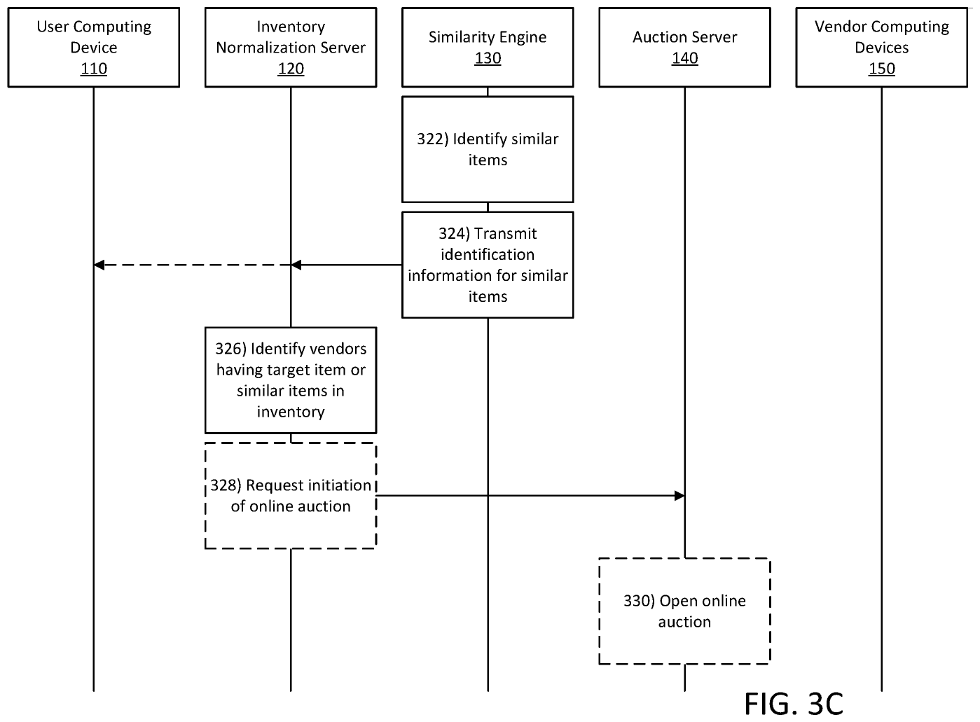

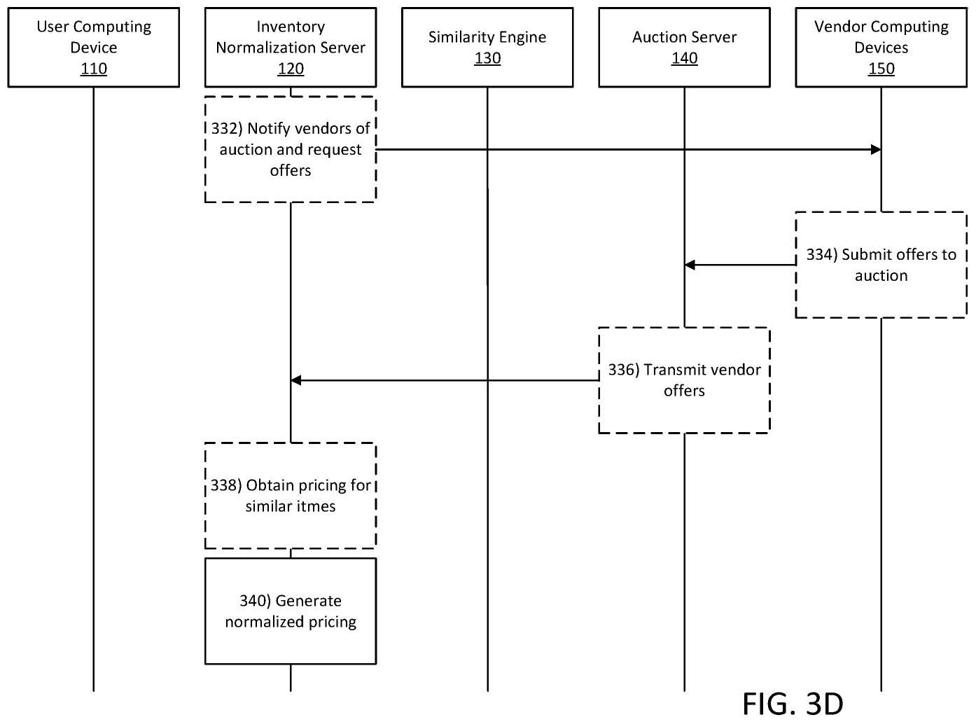

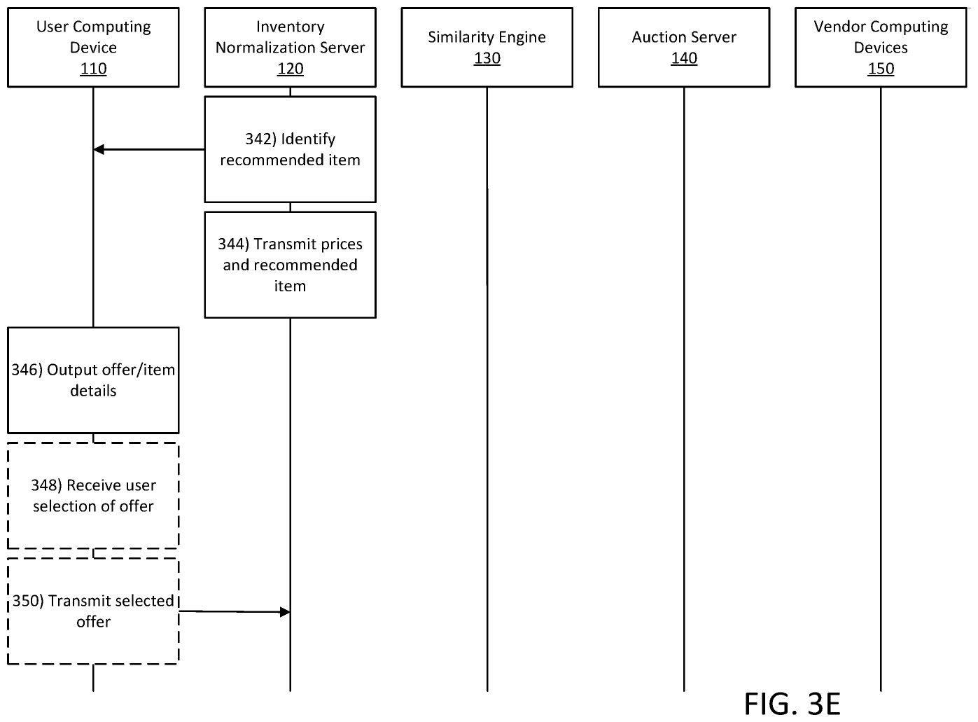

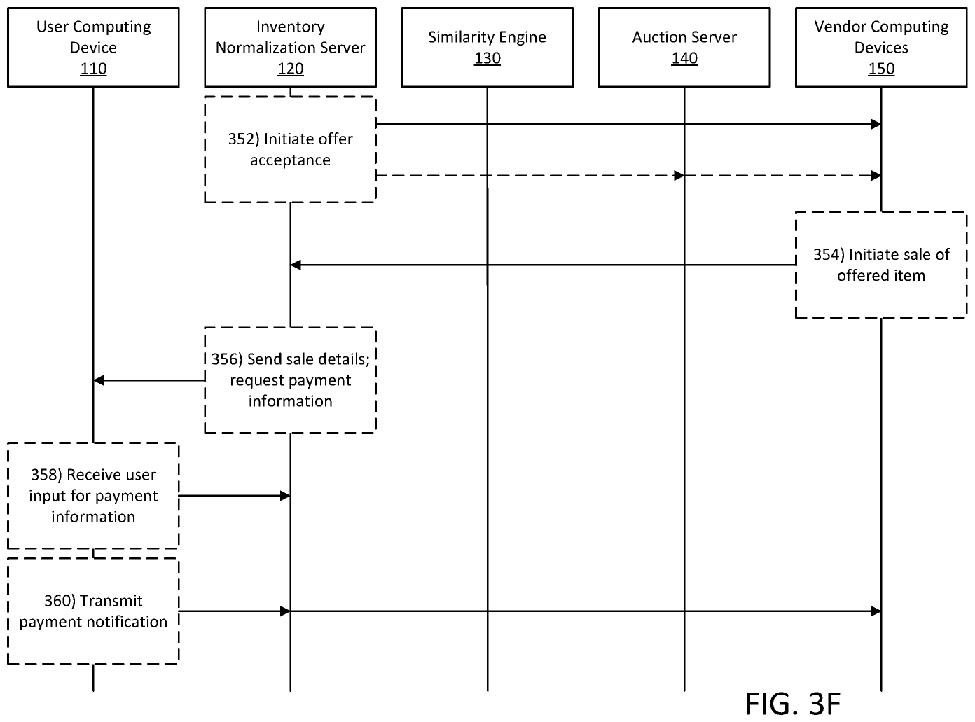

Referring to FIGS. 3A-3F, an example event sequence, for performing the inventory normalization functions of the inventory normalization system 100 and using one or more of the user computing device 110, the inventory normalization server 120, the similarity engine 130, the auction server 140, and the one or more vendor computing devices 150, is provided.

Initially, the inventory normalization system 100 may be configured. For example, the user computing device 110 may receive a request to configure the user computing device 110 with the inventory normalization system 100. In response to the request, the inventory normalization server 120 may control an application that provides computer-executable instructions for performing various inventory normalization functions to be downloaded and installed on the user computing device 110. For instance, the inventory normalization server 120 may cause the inventory identification application 111 to be downloaded to and installed on the user computing device 110. Once downloaded, the inventory normalization server 120 and/or the user computing device 110 may cause the inventory identification application 111 to display one or more user interfaces for configuring the inventory normalization system 100.

The one or more user interfaces may provide options for the user to input personal and/or financial information associated with the user for determining whether the user may prequalify for purchasing and/or financing for a preferred item. For instance, the one or more user options may provide options for the user to input a name, residency information, employment information, income, etc.

The one or more user interfaces may provide options for the user to provide certain permissions to the inventory normalization system 100. For instance, the one or more user interfaces may output options for the user to provide permission for the inventory normalization system 100 to access certain data and/or applications installed and/or operating on the user computing device 110. For instance, the one or more user interfaces may provide options for the user to provide permission for the inventory normalization system 100 to access the user's photos, calendar data, web browsing history data, and/or other data stored on the user computing device 110 or on another device or account (such as a social media account) associated with the user. The one or more user interfaces may additionally output options for the user to provide permission for the inventory normalization system 100 to access an application operating on the user computing device 110, such as a camera application. Access to the user's photos, web browsing history, and/or camera application may be used by the inventory normalization system 100 to identify or receive an image of or information associated with a preferred or target item. The one or more user interfaces may additionally output an option for the user to provide permission for the inventory normalization system 100 to access location information associated with the user computing device 110, such as GPS data, Wi-Fi data, and/or cellular data, in order to identify a location of the user computing device 110 and the user. If the user does not wish to grant permission to collect location information, the user may manually provide their location. The location information may be used by the inventory normalization system 100 to identify the user's proximity to one or more vendors, within a user-defined geographical distance or range, having or potentially having the user's preferred item or similar items in inventory. The one or more user interfaces may provide additional options for configuring the inventory normalization system 100. After the user provides inputs for configuring the inventory normalization system 100, the user computing device 110 and/or the inventory normalization server 120 may store the corresponding user configuration data in the database 160 and/or to a memory associated with the user computing device 110.

Referring to FIG. 3A, at step 302, the user computing device 110 may receive, via one or more user interfaces of the inventory identification application 111, a user input indicating a preferred or target item. The preferred or target item may be an item that the user wishes to purchase. The one or more user interfaces may provide an option for the user to indicate the type of item the user wishes to purchase. For instance, the one or more interfaces may provide an option for the user to indicate a vehicle, a refrigerator, a stove, washing machine, lawn mower, or the like. The one or more user interfaces may provide additional options for the user to provide identification information about the selected type of item that the user would like to purchase.

For example, if the type of item is a vehicle, the one or more user interfaces may provide options for the user to provide identification information for a preferred or target vehicle, such as a vehicle identification number (VIN), a make, a model, a trim, a color, and/or a manufacturer year of the preferred or target vehicle. As another example, if the type of item is a refrigerator, the one or more user interfaces may provide options for the user to provide a brand name, a model number, a manufacturer year, a finish, or the like.

In some cases, the one or more user interfaces, may provide an option for the user to upload an image of the target or preferred item, such as an image of a preferred vehicle. In this case, the inventory identification application 111 may control a camera application executing on the user computing device 110 to capture an image, or the inventory identification application 111 may access one or more storage areas associated with the user computing device 110 or one or more accounts of the user, such as a cloud-based photo storing account, a social media account, or the like, to retrieve an image selected by the user. In some cases, rather than uploading a picture of the target or preferred item, the one or more user interfaces may provide an option for receiving a link to a web page that may include an image of the preferred or target item.

Further, rather than using images of the preferred or target item, the one or more user interfaces may provide an option for receiving a link to a web page that may provide textual details, rather than an image, about the preferred or target item. For example, the web page may include a listing or a description of the preferred or target item, or may access a user-generated manufacturer build, such as generated when a user ‘builds’ a preferred vehicle on a manufacturer's website by identifying various features to include in a preferred vehicle. In some cases, the one or more user interfaces may provide options for the user to, instead of providing a web page address to the generated manufacture build, simply provide the manufacturer name and a manufacturer build code generated by the manufacturer's website when the user built their preferred vehicle. Such a code, when entered into a form provided by a website hosted by the manufacturer or sent via web protocol (HTTP, HTTPS) to an application programming interface (API), may retrieve the user's generated manufacturer build and the associated features relevant to the preferred or target item.

In some cases, the one or more user interfaces may provide an option to access, with permission from the user, a web browsing history of the user to identify a preferred or target item. For instance, the user computing device 110 may, with permission, access the user's web browsing history for a predetermined period of time.

In some cases, the one or more user interface may output an image of a plurality of pre-selected items for the user to choose a particular item that is preferred.

In additional to providing options for a preferred or target item, the one or more user interfaces may additionally provide an option for a user to enter a preferred geographical area or preferred geographical range (e.g., between 1-5 miles, 6-10 miles, 11-25 miles, 26-50 miles, and more than 50 miles) from a user's home location or current location, which should be used to search for the preferred item and/or items similar to the preferred item.

At step 304, the user computing device 110 may transmit the information indicating the preferred or target item and information indicating the preferred geographical area or range for searching for the preferred item or for similar items. For instance, the user computing device 110 may transmit, to the inventory normalization server 120, information indicating a type of item that the user wishes to purchase, such as a vehicle, a refrigerator, a stove, a computer, etc. The user computing device 110 may additionally transmit, to the inventory normalization server 120, identification information for the type of item the user wishes to purchases, such a vehicle identification number (VIN), a make, a model, a trim, a color, a manufacturer year, a brand name, a model number, a finish, or the like. In some cases, the user computing device 110 may transmit, to the inventory normalization server 120, an image or a link to a webpage including an image of the preferred or target item, including textual details about the preferred or target item, or including a user-generated manufacturer build for an item. In some cases, the user computing device 110 may transmit, to the inventory normalization server 120, a manufacturer name and manufacturer build code, which when entered into a form provided by a website associated with the manufacturer may retrieve the user-generated manufacturer build. In some cases, the user computing device 110 may transmit, to the inventory normalization server 120, a web browsing history (for a user-defined period of time) associated with the user. The user computing device 110 may additionally transmit, to the inventory normalization server 120, the information indicating the user's preferred geographical area or range for searching for the preferred item or for similar items.

At step 306, the inventory normalization server may receive the information indicating the preferred or target item and the information indicating the preferred geographical area or range for searching for the preferred item or for similar items and may identify the specific preferred or target item from the user-provided information indicating the preferred or target item. In some cases, the identification process may be fairly straightforward because the user provided precise information identifying the preferred or target item, such as a VIN or a make, model, trim, color, and manufacturer year of a vehicle or the like. In other cases, further analysis and processing of the user-provided information may be necessary to identify the preferred or target item.

For instance, if the information received from the user computing device 110 includes an image of the preferred item, it may be necessary for the inventory normalization server 120 to use one or more computer vision techniques to identify the preferred or target item in the image. The inventory normalization server 120 may employ techniques such as optical recognition, edge detection, grey-scaling, object detection, semantic segmentation, or the like to detect objects in the picture. For example, the inventory normalization server 120 may detect a vehicle or a refrigerator in the uploaded image. The inventory normalization server 120 may then compare the detected object to a database of objects to identify the detected object. The database of objects may be maintained in the database 160 or, in some cases, in one or more databases maintained by one or more third parties. For example, a detected vehicle may be compared to a database of known vehicles to identify the make, model, trim, year of manufacture, or the like of the detected vehicle.

If the information received from the user computing device 110 includes a link to a web page, the inventory normalization server 120 may employ one or more of the above-described computer vision techniques and/or machine learning techniques to determine whether the web page includes an image of the preferred item or includes textual details about the preferred item. For example, to determine whether the web page includes an image of the preferred item, the inventory normalization server 120 may access the web page via the link and use one or more computer vision techniques to detect one or more objects of interest in the web page. Further, such images (and the corresponding features) may be stored, such as within the database 160, for use in training and/or improving algorithms used by the one or more computer vision techniques to identify items in images. Once detected, the inventory normalization server 120 may use the database comparison method above to identify the detected object and determine the preferred item.

In some cases, instead of determining whether the web page includes an image of the preferred item, the inventory normalization server 120 may determine whether the web page includes textual details about the preferred item. For instance, the web page may have identifying information about the preferred item, such as the make or model of a vehicle, included somewhere in the text and, thus, information identifying the preferred item may be extracted from such text. To determine whether the web page includes textual details about the preferred item, the inventory normalization server 120 may use various machine learning and/or to analyze the web page and/or the associated HTML to identify text that corresponds to a description, features, characteristics, and/or attributes of the type of item the user wishes to purchase, as indicated in the received information. In some instances, the inventory normalization server 120 may identify the various relevant textual details about the item using machine learning techniques. For instance, the inventory normalization server 120 may use various machine learning models and/or algorithms, including but not limited to natural language processing (NLP), trained to recognize and assign meaning to various elements of web pages of various types of item listings, such as vehicle listings or appliance listings or the like. Each web page may display data in different ways, requiring such machine learning models/algorithms to extract features in a uniform and reliable manner. For example, in the case where a web page may be standardized, the inventory normalization server 120 may be provided with an HTML selector based on name, class, or id of a certain element, such that text for the given element may be extracted. In some cases, a web page may display data in a grid, in an accordion style drop down box, or in a bulleted list, etc. Such variations may require the aforementioned method of assigning meaning to various elements via NLP or other machine learning models.

Additionally, the various machine learning models and/or algorithms may be trained to recognize various elements of web pages of user-generated manufacturer builds for various types of items and for various manufacturers. For example, the models and/or algorithms may be trained by analyzing various types of web pages associated with the type of item, such as a vehicle, to identify patterns, sequences, relationships, and the like, such that the model/algorithm may able to recognize or detect those elements of the web pages that identify features, characteristics, and/or attributes of the type of item. Once detected, the inventory normalization server 120 may use the database comparison method above to identify the preferred item using the detected features, characters, and or attributes.

If the information received from the user computing device 110 includes a manufacturer name and a manufacturer build code, the inventory normalization server 120 may determine a web site address associated with the manufacture. For example, the inventory normalization server 120 may retrieve the website address from a database (such as the database 160 or a third party database) storing information associating different website addresses with different manufacturers. Upon determining the website address, the inventory normalization server 120 may access the website and corresponding web page and may employ one or more of the above-described computer vision techniques and/or machine learning techniques to identify the preferred item.

If the information received from the user computing device 110 includes information associated with the user's web browsing history, the inventory normalization server 120 may, based on analyzing the web browsing history, determine types of items the user has searched for within the period of time represented by the web browsing history. For instance, the inventory normalization server 120 may detect that the user has conducted more than a threshold amount or percentage of searches for a particular brand and model of a particular type of item, such as a washing machine. Additionally or alternatively, the inventory normalization server 120, using various computer vision and/or machine learning techniques such as those described above, may detect, on more than a threshold number or percentage of the web pages associated with the user's web browsing history, images or textual descriptions of a particular brand and model of a particular type of item.

The inventory normalization server 120, after identifying the preferred or target item, may transmit a request to the user computing device 110 for confirmation, by the user, of the identified preferred or target item. The user computing device 110 may cause, via the inventory identification application 111, one or more user interfaces to display information identifying the determined preferred or target item and may request the user's confirmation of whether the item is the user's preferred or target item. If the user indicates that the determined item is not the user's preferred item, the user may be requested, via one or more interfaces of the inventory identification application 111, to provide additional information indicating the preferred or target item, and the process may, in this case, return to step 302. Otherwise, the user computing device 110 may transmit a confirmation message to the inventory normalization server 120 indicating that the preferred item has been correctly determined. In some cases, the inventory normalization server 120 may additionally make a prequalification determination regarding the user's financial ability to purchase or finance the preferred item. The inventory normalization server 120 may determine a specific dollar amount for which the user is prequalified. The inventory normalization server 120 may transmit, to the user computing device 110, a notification indicating whether the user has received a prequalification to purchase/finance the item and/or a prequalification amount.

After identifying the preferred or target item, then at step 308, the inventory normalization server 120 may determine features associated with the preferred or target item. For instance, the inventory normalization server 120 may use the database 160 or one or more third party databases to look up attributes and/or features associated with the preferred or target item. These attributes and/or features may be the standard or default features associated with the preferred or target item. In some cases, the user's preferred or target item may have custom or user-selected features. For example, when the user generates a manufacturer build, typically the manufacturer will allow the user to customize the features included in the item. When generating a build for the custom item, the manufacturer may allow the user to identify features in addition to the standard features, that the user would prefer in the customized item. In some cases, the manufacturer will additionally or alternatively allow for the removal of one or more otherwise standard features in the customized item. Accordingly, in the case where the information identifying a user-generated manufacturer build was provided from the user computing device 110, to the inventory normalization server 120, at step 304, the inventory normalization server 120 may be able to determine more precise features that the user is interested in for the preferred item. In such cases, the inventory normalization server 120 may use various machine learning and/or character recognition techniques to analyze the web page associated with the user-generated manufacturer build and/or the associated HTML of the user-generated manufacturer build to identify text that corresponds to features included in the custom built item.

At step 310, the inventory normalization server 120 may normalize and/or vectorize the extracted features of the preferred item. To perform the normalization, the inventory normalization server 120 may maintain a database, such as the database 160, that stores a mapping of various features identified by their manufacturer feature name to a corresponding generic feature name. The database may be created by using various machine learning techniques to perform web scraping of industry-related articles, websites, etc. for various types of items, such as vehicles, appliances, or the like to identify terms associated with different manufacturers that are commonly or frequently used together. For instance, the machine learning algorithms may analyze websites and articles related to vehicles and may detect that the term “XDRIVE” is frequently (more than a threshold amount of times) used with the term “all-wheel drive.” The machine learning algorithms may also detect that the terms “4MATICA” and “4MOTION” are also frequently used with the term “all-wheel drive.” In recognizing that multiple terms are frequently used together with the same term, the inventory normalization server 120 may determine that XDRIVE, 4MATICA, and 4MOTION are manufacturer names and that all-wheel drive is a generic name. The inventory normalization server 120 may, as a result, map the terms XDRIVE, 4MATICA, and 4MOTION to the generic term all-wheel drive.

The inventory normalization server 120 may normalize each of the extracted features. Normalizing the features may refer to converting an identification of such features to, instead, reflect the corresponding generic names for the features. Accordingly, the inventory normalization server 120 may identify, in the database 160, the generic name for each feature where a manufacturer feature name was extracted in step 308. For instance, if the preferred item was identified as a 2022 BMW X5, one of the extracted features may be “XDRIVE.” Because XDRIVE is a manufacturer-specific named feature and not the generic name of a feature (as the inventory normalization server 120 may determine by searching the database 160), the inventory normalization server 120 may access the database 160 to search for the generic term for XDRIVE and may retrieve all-wheel drive as the generic term. The generic term may then be used as the normalized name of the feature. The inventory normalization server 120 may store, in the database 160, a list of the normalized names of the features associated with the preferred item.

In some cases, the inventory normalization server 120 may additionally vectorize features associated with the preferred or target item. Vectorizing the features may refer to generating a uniform data set of a universe of features that may be associated with a particular item or a particular type of item. Accordingly, the inventory normalization server 120 may identify a universe of features that may be associated with the preferred item. For instance, if the preferred item is a vehicle, the inventory normalization server 120 may identify as the universe of features associated with a vehicle, features such as sedan, SUV, four doors, automatic windows, air conditioning, heated seats, sunroof, navigation, automatic wipers, heated steering wheel, all-wheel drive, leather seats, garage door opener, etc. The inventory normalization server 120 may store in a database, such as the database 160, a listing of the universe of features and an indication of whether the preferred item includes that feature. The inventory normalization server 120 may determine whether the preferred item includes the various listed features based on the listing of normalized features associated with the preferred item. In some cases, one hot encoding may be used to map each of the features from the universe of features to a Boolean value based on whether the preferred item include the feature (e.g. 0 if not included, 1 if included). In some cases, the features may be mapped to values that indicate the closeness of the listed feature to a feature of the preferred item. For instance, if the feature is “isCoupe” and the preferred item is a sedan, the value for isCoupe might be 0.5, whereas if the preferred item is a van the value might be 0. Using the database 160, the inventory normalization server 120 may store a listing of the vectorized features, such as the example listing for the preferred item 2022 BMW X5 provided below in Table 1.

TABLE 1
Preferred Item: 2022 BMW X5

| Features | Included? |
|---|---|
| isSedan | 0 |
| isSUV | 1 |
| hasFourDoors | 1 |
| hasAutoWindows | 1 |
| hasAC | 1 |
| hasHeatedSeats | 1 |
| hasSunroof | 0 |
| hasNavigation | 0 |
| hasAutoWipers | 1 |
| hasHeatedSteeringWheel | 0 |
| hasAWD | 1 |
| hasLeatherSeats | 0 |
| hasGarageDoorOpener | 0 |

The listing of vectorized features may provide a uniform dataset of features that may be useful when comparing a preferred item to one or more other potentially similar items. Comparing the vectorized features ensures that like features may be compared to one another. For instance, the listing of vectorized features may be used by the similarity engine 130 to identify one or more similar items having features similar to the preferred item.

Referring to FIG. 3B, at step 312, the inventory normalization server 120 may generate a baseline price for the preferred or target item and for one or more of the associated features of the preferred item. The inventory normalization server 120 may determine the baseline price by analyzing one or more websites to determine prices for the preferred item within the user's specified geographical area or range. The inventory normalization server 120 may take the average or a median of such prices to determine the baseline price for the preferred or target item. The inventory normalization server 120 may additionally determine, in a similar manner, prices for or the monetary values for one or more of the features associated with the preferred or target item. In some cases, the inventory normalization server 120 may additionally identify the value of features not included in the preferred item, such as shown in Table 2 below. Such prices or values might not be used in the generated baseline price for the preferred item, but may be useful in comparing the preferred item to similar items that may have one or more features that the preferred item does not have. The inventory normalization server 120 may store, in the database 160 and together with the listing of the vectorized features for the preferred item, the baseline price of the preferred item and/or the features.

TABLE 2
Preferred Item: 2022 BMW X5
Baseline Price: $50,000

| Features | Included? | Mkt Value |
|---|---|---|
| isSedan | 0 | $5,000 |
| isSUV | 1 | $10,000 |
| hasFourDoors | 1 | $7,000 |
| hasAutoWindows | 1 | $1,000 |
| hasAC | 1 | $2,500 |
| hasHeatedSeats | 1 | $2,000 |
| hasSunroof | 0 | $3,000 |
| hasNavigation | 0 | $3,000 |
| hasAutoWipers | 1 | $500 |
| hasHeatedSteeringWheel | 0 | $1,000 |
| hasAWD | 1 | $5,000 |
| hasLeatherSeats | 0 | $2,000 |
| hasGarageDoorOpener | 0 | $500 |

At step 314, the inventory normalization server 120 may transmit, to the user computing device 110, the baseline price for the preferred or target item and the prices for one or more of the associated features. The user computing device 110 may cause the inventory identification application 111 to output one or more user interfaces to display the received baseline price for the preferred or target item and prices for one or more of the associated features. The inventory normalization server 120 may additionally transmit, to the user computing device 110, a request for information indicating a subjective importance, to the user, of each of the various features. For instance, while the item may be the user's preferred or target item, the item may include certain features that are of particular importance to the user and others that may be of lesser importance. The user computing device 110 may cause the inventory identification application 111 to output one or more user interfaces that may allow the user to indicate a degree of importance, an importance weighting, or an importance value for one or more of the preferred features or attributes.

Accordingly, at step 316, the user computing device 110 may receive a user input indicating a degree of importance or an importance weighting for one or more of the various features associated with the preferred item. For instance, the user may indicate a degree of importance/importance weighting such as, “must have,” “important,” “neutral,” “not important,” “do not want,” or the like. The degree of importance may be represented by a numerical score or an importance value such as 5, 4, 3, 2, 1, or the like. The importance value may also serve the purpose of providing an indication of how the user values the feature from a monetary standpoint. For instance, a user may place more value on a particular feature that the user subjectively must have than the objective or market price or value of that feature. For instance, if the user's preferred item is a vehicle, and all-wheel drive is of particular importance to the user such that the user indicates all-wheel drive as a “must have” feature, the user may value all-wheel drive more than the objective price or value (such as the baseline price/value transmitted at step 314) of the feature. Accordingly, the user may expect a significant discount on a vehicle that does not include all-wheel drive—a discount greater than simply the market value of all wheel drive. On the other hand, heated seats may not be of particular importance to the user and the user, as a result, may indicate the feature as a “not important” feature and may not be willing to pay any more than the objective price or value for the feature. In some cases, the user may indicate a feature that the user does not want. For instance, the user may indicate that they do not want leather seats. The user may indicate this feature as a “do not want” feature and, while the feature may actually increase the market value of the vehicle, it may decrease the value of the vehicle to the user and, thus, the user may not be willing to pay even the market price or value for the feature. As with the missing important feature, with an included unwanted feature, the user may expect a significant discount to be willing to purchase a vehicle with an unwanted feature. The one or more user interfaces may provide the user with options for associating, with each of the different degrees of importance or importance values, a percentage of the feature price or value that reflects the user's value for a given feature of that degree of importance. For example, the user may indicate that a feature indicated as a “must have” degree of importance has a value to the user of 120% of the objective price or value of the feature. Thus, any item missing this feature should be discounted at a rate of 120% of the value of the feature. For a feature having an “important” degree of importance, the user may indicate that a feature of that degree of importance has a user value of 110%. Thus, any item missing this feature should be discounted at a rate of 110% of the value of the feature. For a feature having a “neutral” degree of importance, the user may indicate that a feature of that degree of importance has a value of 100%— i.e., the user would be willing to pay the objective price or value for an item with that feature, but no more. In this case, any item missing this feature should be discounted at a rate of 100% of the value of the feature—essentially the item should be discounted at the market rate for the feature. For a feature having a “not important” degree of importance, the user may indicate that a feature of that degree of importance has a value of 50%— i.e., the user would be willing to pay some reduced amount of the objective price or value for an item with that feature, but not the full value since the item is not of any particular importance to the user. And for a feature having a “do not want” degree of importance, the user may indicate that a feature of that degree of importance has a value of 0%— i.e., the user would not be willing to pay anything for such a feature. In this case, the item is more valuable to the user without the feature and, therefore, if the feature is missing the user may not necessary expect a discount. However, if an unwanted feature is included in an item, the user may not want to pay for such a feature and would expect a discount of the market value of the feature to accept an item including the unwanted feature. In some cases, instead of providing a percentage to be applied to all features having a particular degree of importance, the user may provide absolute discount amounts for one or more of the features. In some cases, the user may also provide an indication of a discount rate or absolute discount amount based on a distance of the vendor from the user. For instance, the user may wish to pay less for an item that is located further away from her than another that might be located closer. The user may specify, for example, a rate of discount for every mile beyond a predetermined distance from the user's location that the vendor is located.

At step 318, the user computing device 110 may transmit the feature importance information to the inventory normalization server 120. The feature importance information may include the user-defined percentages (the user values) associated with each of the importance values and the importance values associated with one or more of the features of the preferred or target item. The inventory normalization server 120 may receive the feature importance information and may add the importance information to the stored vectorized listing of features for the preferred item. In some cases, the inventory normalization server 120 may additionally calculate the user value for each of the various features, based on the user-assigned percentages (or absolute value amounts) from step 316. The inventory normalization server 120 may store, in the database 160, the updated vectorized listing of features, such as the example listing shown below in Table 3.

TABLE 3
Preferred Item: 2022 BMW X5
Baseline Price: $50,000

| | | | Impor- | |
|---|---|---|---|---|
| | | Mkt | tance | User |
| Features | Included? | Value | Value | Value |
| isSedan | 0 | $5,000 | 1 | $0 |
| isSUV | 1 | $10,000 | 5 | $12,000 |
| hasFourDoors | 1 | $7,000 | 5 | $8,400 |
| hasAutoWindows | 1 | $1,000 | 4 | $1,100 |
| hasAC | 1 | $2,500 | 4 | $2,750 |
| hasHeatedSeats | 1 | $2,000 | 3 | $2,000 |
| hasSunroof | 0 | $3,000 | 1 | $0 |
| hasNavigation | 0 | $3,000 | 4 | $3,300 |
| hasAutoWipers | 1 | $500 | 3 | $500 |
| hasHeatedSteeringWheel | 0 | $1,000 | 2 | $500 |
| hasAWD | 1 | $5,000 | 5 | $6,000 |
| hasLeatherSeats | 0 | $2,000 | 1 | $0 |
| hasGarageDoorOpener | 0 | $500 | 2 | $250 |

At step 320, the inventory normalization server 120 may request, from the similarity engine 130, information identifying one or more items similar to the preferred item. The request may include information identifying the preferred or target item and the vectorized listing of features associated with the preferred item and including the importance information.

Referring to FIG. 3C, at step 322, the similarity engine 130 may receive the information identifying the preferred or target item and the vectorized listing of features associated with the preferred or target item, and may identify one or more items similar to the preferred or target item. The similar items may be those items having a threshold amount of features that are similar to those features having a threshold level of importance to the user. In some cases, the similarity engine 130 may, additionally or alternatively, identify the most similar items using artificial intelligence, including neural networks machine learning algorithms, such as by calculating the weighted Euclidean distance or cosine distance between vectors of the preferred item and a plurality of other items or, alternatively or additionally, by applying a clustering algorithm (e.g., a K-means clustering algorithm) to a data set comprising a data points representing the preferred or target item and a plurality of other items of the same type.

In particular, K-means clustering techniques may be used to understand relationships between a plurality of items that may not be easily identifiable. For example, in the context of vehicles, using K-means clustering techniques, multiple clusters of like items may be revealed. For instance, one cluster of vehicles may emerge around mid-size luxury vehicles (e.g., BMW 3 SERIES, MERCEDES C CLASS, etc.), another cluster of vehicles may emerge around sports vehicles (e.g., PORSCHE 911, MCLAREN 720S, etc.), etc. Such clusters may emerge based on features intrinsic to vehicles, for example, they may all have similar prices, engine types, fuel efficiencies, etc. Accordingly, in K-means clustering, k data points may be randomly selected as a cluster center, also referred to as centroid, of a plurality of clusters of datapoints, where k is a positive integer. For each remaining data point (e.g., those not selected as a centroid), a distance (Euclidean or otherwise) may be computed relative to each centroid and the data point may be assigned to the centroid with the minimum distance (e.g., the centroid closest to that data point). A data point that is assigned to centroid n (where n is an integer less than or equal to k), may be referred to as a member of cluster n. A new centroid for each cluster may be elected as that which minimizes the total sum of distances between it and all other data points within each cluster. The process of electing a new centroid for each cluster may then be repeated. For instance, each data point may be assigned to a cluster that minimizes a distance to the newly elected centroids and a new centroid may be computed for each cluster until the process reaches convergence (e.g., centroid means are not changing). For example, where the preferred item is a vehicle, the data set may comprise a data point representing the preferred or target vehicle and a plurality of data points representing the plurality of other vehicles. In some cases, the plurality of other vehicles may be those within one or more vendor's inventory. Each of the plurality of other items may have associated with it, a vectorized listing of that item's features. The similarity engine 130 may score each of the plurality of other items based on the features of each item and based on a weight assigned to each feature based on the user-defined importance value associated with that feature as indicated in the vectorized listing of features for the preferred item. Accordingly, each item of the plurality of other items may be associated with a similarity score that represents the similarity of that item to the user's preferred item. Items having more features of importance to the user will be scored higher than those with fewer such important features. The plurality of data points, representing the plurality of other items, may be distributed in a plurality of clusters. The plurality of clusters may be plotted on, for example, an n-dimensional graph using principal component analysis (PCA), where the dimensions are reduced to one or more principal components that are linear combinations of the original features that seek to maximize the amount of explained variance found within the original data. Dimension reduction allows for the creation of simpler models that reduce the possibility of overfitting. At the conclusion of the K-Means clustering algorithm, the centroid for each cluster and the cluster assignment for each data point may be output by the similarity engine 130 to provide an identification of the one or more similar items. In the case where the preferred item is one of the data points representing the plurality of other items (such as a vehicle currently in a vendor's inventory), the one or more similar items may be identified as those within the same cluster as the preferred item. Alternatively, in the case where the preferred item is not one of the one of the data points representing the plurality of other items, the one or more similar items may be identified as those belonging to a cluster whose centroid has the minimum distance to the data point representing the preferred item (e.g., k nearest neighbors). Such techniques for identifying similar items, such as vehicles, are disclosed in further detail in U.S. patent application Ser. No. 17/104,684.

At step 324, the similarity engine 130 may transmit, to the inventory normalization server 120, information identifying the similar items identified in step 322. The similarity engine 130 may additionally transmit to the inventory normalization server 120, the vectorized listing of features for each of the similar items. The inventory normalization server 120 may store the identified similar items and their corresponding vectorized listing of features in the database 160. In some cases, the inventory normalization server 120 may use the prequalification determination made at step 306 to filter the one or more similar items identified by the similarity engine 130 to those which the user may be able to afford, e.g., those that do not exceed the user's prequalification amount. In some cases, the inventory normalization server 120 may additionally transmit the information identifying the similar items and the vectorized listing of features to the user computing device 110 and the user computing device 110 may cause the inventory identification application 111 to output, to one or more user interfaces, the identified similar items and corresponding features. In some cases, the one or more user interfaces may provide options for the user to modify, delete or add items to the identified similar items.

At step 326, the inventory normalization server 120 may determine one or more vendors having the preferred or target item and/or one or more of the identified similar items in inventory and/or available for purchase. The inventory normalization server 120 may access one or more devices associated with vendors located within the user-specified geographical area or geographical range of the user computing device 110. For instance, the inventory normalization server 120 may access the one or more vendor computing devices 150 (and inventory data stored thereon), that are located within the user-specified geographical area or geographical range of the user computing device 110, to determine whether the associated vendors have, in inventory and/or available for purchase, the preferred/target item or one or more of the similar items. In some cases, the inventory normalization server 120 may access or receive, from one or more third party computing devices, such inventory data. In some cases, the inventory normalization server 120 may be configured to execute a script to perform web scraping of one or more websites associated with the one or more vendor computing devices 150 to determine whether the vendors have, in inventory, the preferred/target item or one or more of the identified similar items. In some cases, the inventory normalization server 120 may transmit, to the user computing device 110, a notification indicating the vendors identified as having the preferred or the similar items in inventory and/or available for purchase. In some cases, the user computing device 110, may output a list of the identified vendors and their corresponding locations or may output a map indicating locations of the identified vendors.

In some cases, step 326 may be performed prior to step 322, such that the universe of the other items analyzed to determine a similarity to the preferred or target item is narrowed down prior to determining the similar items. In the case when step 326 is performed prior to step 322, then at step 326, the inventory normalization server 120 may first identify the items that are in inventory and available for purchase at one or more vendors within the user-specified geographical area or range. The identified available items (and their associated features) may then be transmitted to the similarity engine 130 at step 322 along with the information identifying the preferred or target item and the vectorized listing of features associated with the preferred or target item. The identified available items may be used by the similarity engine 130 as the plurality of other items to be included in the data set for identification of the one or more similar items. In this way, the similarity engine 130 may only identify similar items of those items that are actually currently in inventory and available for purchase within the user-specified geographical area or range.

At step 328, the inventory normalization server 120 may send a request to the auction server 140 for initiation of an online auction for the identified vendors to present their best offers for the preferred or target item and/or for the one or more of the similar items. The vendors may compete against one another in the online auction for the user's business. The inventory normalization server 120 may include with the request to the auction server 140, information identifying the vendors and the preferred item or similar items each has in inventory for inclusion in the online auction. In some cases, the inventory normalization server 120 may include, in the request to the auction server 140, information indicating the prequalification determination made at step 306, to be used by vendors so they may determine whether to participate in the auction, e.g., the vendor may first want to be sure that the user is able to proceed with a provided offer. In some cases, the inventory normalization server 120 might not request the initiation of the online auction and may instead receive pricing for the similar items by other means, such as set forth in step 338.

At step 330, the auction server 140 may open an online auction and referring to FIG. 3D, at step 332, may transmit a notification, to the one or more vendor computing devices 150 associated with the identified vendors, requesting offers for the preferred item and/or the similar items that the particular vendors have in inventory. The notification may indicate a date by which all offers must be submitted. The vendors might not receive information identifying the user, such that the user may remain anonymous until the user decides to accept one of the bids. In some cases, the notification may include basic financial information associated with the user, such as income, years of employment, credit score, amount of down payment the user is willing to make, etc. so that the vendor may make an informed offer to the user. In some cases, the notification may include the prequalification determination made at step 306 so that the vendor may make a determination about whether to participate in the auction, e.g., to alleviate concerns by the vendor that the user may be able to afford or be approved for financing for the offered item. Steps 330 and 332 may be optional and might not be performed in the case where the inventory normalization server 120 does not request the initiation of the online auction in step 328.

At step 334, one or more of the one or more vendor computing devices 150 may submit one or more offers made by the vendors to the auction server 140. In this case, one or more of the one or more vendor computing devices 150 may transmit a message, to the auction server 140, including information identifying the preferred item or one of the similar items and an offer price. Step 334 may be optional and might not be performed in the case where the inventory normalization server 120 does not request the initiation of the online auction in step 328.

At step 336, auction server 140, may transmit to the inventory normalization server 120 the vendor offers, including the information identifying the preferred item or one of the similar items and the corresponding offer prices. Step 336 may be optional and might not be performed in the case where the inventory normalization server 120 does not request the initiation of the online auction in step 328.

In the case where steps 328-336 might not be performed, the inventory normalization server 120 may, instead at step 338, otherwise retrieve pricing for the one or more similar items identified as being in inventory and available from the identified vendors (e.g., at steps 322-326). For instance, the inventory normalization server 120 may transmit a request to the one or more vendor computing devices 150 associated with the identified vendors for general pricing of the one or more similar items. In some cases, the inventory normalization server 120 may access one or more web pages associated with the one or more vendor computing devices 150 and may employ one or more of the above-described computer vision techniques and/or machine learning techniques or may analyze the corresponding HTML to extract pricing information for the one or more similar items from the web page. In some cases, the inventory normalization server 120 may obtain general pricing information for the one or more similar items from a third-party computing device or database. In some cases, the database 160 may maintain pricing for particular items and the pricing for the one or more similar items may be retrieved from the database 160.

At step 340, the inventory normalization server 120 may generate a normalized price for each of the similar items based on a received offer price (step 3366) or based on the obtained general price (step 338). The normalized price may be calculated based on the baseline pricing for the preferred item having the preferred features and the features associated with the corresponding item. The normalized price may be a price calculated to reflect a discount for important features missing from the similar item and/or unimportant/unwanted features included in the similar item. For instance, the inventory normalization server 120 may generate a normalized price for the similar item by discounting for important features missing from the similar item and/or unimportant/unwanted features included in the similar item. The discount may be based on the importance to the user of the missing/included feature and the discount or user value assigned, at step 316, by the user for such features. In some instances, the inventory normalization server 120 may discount further based on a distance of the vendor from the user.

By way of example, assume a first scenario where similar Item 1 from Vendor 1 is priced at $47,000 (either based on an offer price or based on general pricing), and similar Item 2 from Vendor 2 is priced at $49,000. As noted above, the baseline price for the user's preferred item may be $50,000. While prices for both items are below the baseline price and the price for Item 1 is the lowest from a strictly monetary standpoint, the prices alone may have little meaning or value to the user without determining whether the similar items include the features deemed important to the user. And where they do not, in order to provide the user with a comparison that is of relevance to the particular user, it may be necessary to generate normalized prices for such similar items, prices that reflect a discount for missing and/or unwanted features.

TABLE 4

| | | | | | Similar | Similar |
|---|---|---|---|---|---|---|
| Preferred Item: 2022 BMW X5 | | | | | Item 1 | Item 2 |
| Baseline Price: $50,000 | | | | | Price: | Price: |
| | | Importance | Mkt | User | $47,000 | $45,000 |
| Features | Incl? | Value | Value | Value | Incl? | Incl? |
| isSedan | 0 | 1 | $5,000 | $0 | N | N |
| isSUV | 1 | 5 | $10,000 | $12,000 | Y | Y |
| hasFourDoors | 1 | 5 | $7,000 | $8,400 | Y | Y |
| hasAutoWindows | 1 | 4 | $1,000 | $1,100 | Y | Y |
| hasAC | 1 | 4 | $2,500 | $2,750 | Y | Y |
| hasHeatedSeats | 1 | 3 | $2,000 | $2,000 | Y | Y |
| hasSunroof | 0 | 1 | $3,000 | $0 | N | N |
| hasNavigation | 0 | 4 | $3,000 | $3,300 | N | N |
| hasAutoWipers | 1 | 3 | $500 | $500 | Y | N |
| hasHeatedSteeringWheel | 0 | 2 | $1,000 | $500 | N | N |
| hasAWD | 1 | 5 | $5,000 | $6,000 | N | Y |
| hasLeatherSeats | 0 | 1 | $2,000 | $0 | N | N |
| hasGarageDoorOpener | 0 | 2 | $500 | $250 | N | N |

In this scenario, as shown in Table 4, Item 1 from Vendor 1 may have all of the same features as the preferred vehicle, except that it is missing one feature deemed to be of significant importance to the user—all-wheel drive—a must have feature. Item 2 from Vendor 2 is also missing only one feature that is included in the preferred vehicle, but in this case the feature—automatic wipers—is not deemed as important to the user. Accordingly, a normalized or adjusted price may be generated for the first item. In this case, the inventory normalization server 120, starting with the baseline price of $50,000, may discount for the missing all-wheel drive feature, which the user has valued at $6,000. In this case, the inventory normalization server 120 may determine that an item without all-wheel drive should cost no more than $44,000 ($50,000-$6,000). Accordingly, the normalized price for Item 1, relative to the preferred item, may be $44,000. Likewise, for Item 2, the inventory normalization server 120 may discount for the missing automatic wipers. In this case the discount is equivalent to the market value of the feature and the inventory normalization server 120 may determine that an item without automatic wipers should cost no more than $49,500 ($50,000-$500). Accordingly, the normalized price for Item 2 may be $49,500. The inventory normalization server 120 may further calculate the difference between the offer/general prices and the normalized prices as shown in Table 5.

TABLE 5

| | Offer/General | | |
|---|---|---|---|
| Similar Items | Price | Normalized Price | Difference |
| Item 1 | $47,000 | $44,000 | 6.81% |
| Item 2 | $49,000 | $49,500 | −1.01% |

At step 342, the inventory normalization server 120 may identify a recommended item from among the similar items. For instance, the inventory normalization server 120 may determine that Item 2, while more expensive than Item 1, is a better deal for the user than Item 1 because the difference between Item 2's price and the normalized price for the Item 2 is less than the difference between Item 1 's price and the normalized price for Item 1. In this scenario, the user may realize a 1.01% savings by purchasing Item 2. The inventory normalization server 120 may, therefore, identify Item 1 as the recommended item.

Returning to step 340, by way of another example, assume a second scenario where Item 1 from Vendor 1 is priced at $47,000 and Item 2 from Vendor 2 is priced at the same amount.

TABLE 6

| | | | | | Similar | Similar |
|---|---|---|---|---|---|---|
| Preferred Item: 2022 BMW X5 | | | | | Item 1 | Item 2 |
| Baseline Price: $50,000 | | | | | Price: | Price: |
| | | Importance | Mkt | User | $47,000 | $47,000 |
| Features | Incl? | Value | Value | Value | Incl? | Incl? |
| isSedan | 0 | 1 | $5,000 | $0 | N | N |
| isSUV | 1 | 5 | $10,000 | $12,000 | Y | Y |
| hasFourDoors | 1 | 5 | $7,000 | $8,400 | Y | Y |
| hasAutoWindows | 1 | 4 | $1,000 | $1,100 | Y | Y |
| hasAC | 1 | 4 | $2,500 | $2,750 | Y | Y |
| hasHeatedSeats | 1 | 3 | $2,000 | $2,000 | Y | Y |
| hasSunroof | 0 | 1 | $3,000 | $0 | N | N |
| hasNavigation | 0 | 4 | $3,000 | $3,300 | N | N |
| hasAutoWipers | 1 | 3 | $500 | $500 | Y | Y |
| hasHeatedSteeringWheel | 0 | 2 | $1,000 | $500 | N | N |
| hasAWD | 1 | 5 | $5,000 | $6,000 | N | N |
| hasLeatherSeats | 0 | 1 | $2,000 | $0 | N | Y |
| hasGarageDoorOpener | 0 | 2 | $500 | $250 | N | N |

In this scenario, as shown in Table 6, Item 1 from Vendor 1 may have all of the same features as the preferred vehicle, except that it may be missing all-wheel drive—a must have feature. Item 2 from Vendor 2 is also missing all-wheel drive, but additionally includes leather seats—an unwanted feature. Accordingly, a normalized or adjusted price may be generated for the Item 1. In this case, the inventory normalization server 120 may determine that an item without all-wheel drive should cost no more than $44,000 ($50,000-$6,000). Accordingly, the normalized price for Item 1 may be $44,000. Likewise, for Item 2, the inventory normalization server 120 may discount for the missing all-wheel drive, but may also discount for the added unwanted feature of leather seats. In this case, the user has indicated that he wants to pay nothing for leather seats, not even the market value. In this case, the inventory normalization server 120 may determine that an item without all-wheel drive, but with leather seats should cost no more than $43,500 ($50,000-$6,000-$500). Accordingly, the normalized price for Item 2 may be $43,500. The inventory normalization server 120 may further calculate the difference between the offer/general prices and the normalized prices, as shown in Table 7.

TABLE 7

| | Offer/General | | |
|---|---|---|---|
| Similar Items | Price | Normalized Price | Difference |
| Item 1 | $47,000 | $44,000 | 6.81% |
| Item 2 | $47,000 | $43,500 | 7.44% |

In some cases, such as where multiple offers are received for the same price or where general pricing is the same for multiple items, the similarity score, determined at step 322, and associated with the item, may be used to further normalize the prices. For instance, the similarity scores for the multiple items may be scaled between 0 and 1, and the price for each of the items may be divided by the corresponding scaled similarity score. By way of a non-limiting example, if two items are both priced at $20,000, and Item 1 has a scaled similarity score of 0.5 and Item 2 has a scaled similarity score of 0.8, the normalized prices may be calculated as $40,000 ($20,000 divided by 0.5) for Item 1 and $25,000 for Item B ($20,000 divided by 0.8).

Referring to FIG. 3E, at step 342, the inventory normalization server 120 may identify a recommended item from among the similar items. For instance, the inventory normalization server 120 may determine that while Item 1 and Item 2 are the same price, and while Item 2 actually has more features than Item 1, Item 1 is a better deal than Item 2 for the user because the difference between Item 1's price and the normalized price for Item 1 is less than the difference between Item 2's price and the normalized price for Item 2. In this scenario, both item's prices are more than the respective normalized prices, but the price for Item 1 may be determined to be the better of the two, and the inventory normalization server 120 may identify Item 2 as the recommended item. In some cases, the inventory normalization server 120, may recommend neither of the items, such as when all prices are above their respective normalized prices, and may instead recommend that the user await identification of further similar items in inventory. In some cases, the inventory normalization server 120 may also recommend none of the items where the price may be above the user's prequalification amount.

At step 344, the inventory normalization server 120 may transmit, to the user computing device 110, each of the offers and/or the general pricing for each of the similar items. For instance, the inventory normalization server 120 may transmit the offer prices or general prices, the normalized prices, and the differences, along with an indication of the recommended item for purchase.

At step 346, the user computing device 110 may control the inventory identification application 111 to output, via one or more user interfaces, the offers and/or the general pricing for each of the similar items. The name of the vendor, location of vendor, identification of similar and/or offered items and features, offer prices, general pricing, normalized prices, differences, an indication of a recommended item for purchase, or the like may be output. While providing the user with specific items that have been offered for purchase at a vendor-specified price and a recommendation of a best offer, it may also be useful to provide the user with the similar items and a recommendation of the best similar item based on the user's preferences and the normalized prices for the similar items. This may be useful for the user to then negotiate one on one with a specific vendor for the similar item. For example, the user may indicate to the vendor that she likes the similar item, but that it does not include exactly what the user is looking for in terms of certain features—in view of the inexact match the user may use the normalized price of the item as a baseline for beginning negotiation with the vendor.

At step 348, the user computing device 110 may control the inventory identification application 111 to output one or more options that allow the user to make a selection of one of the received offers. The user computing device 110 may receive a user selection of one of the offers. Step 348 may be optional in the event an auction is not initiated, an offer is not received, or where the user does not wish to purchase an offered item.

At step 350, where the user has accepted an offer, the user computing device 110 may transmit an indication of the selected offer to the inventory normalization server 120 and, referring to FIG. 3F, at step 352, the inventory normalization server 120 may initiate a process with the one of the one or more vendor computing devices 150 corresponding to the vendor associated with the accepted offer. For instance, the inventory normalization server 120 may send a message to a first vendor computing device 150a, of the one or more vendor computing devices 150, indicating that the user has accepted an offer submitted by the first vendor computing device 150a. In some cases, instead of initiating the offer acceptance directly with the vendor, the inventory normalization server 120 may initiate the offer via the auction server 140 and the auction server 140 may communicate with the first vendor computing device 150a to initiate the offer acceptance.

At step 354, the first vendor computing device 150a may initiate a sale of the offered item by generating a bill of sale, coordinating any financing, verifying the user's financials, preparing to transfer title of the offered item, or the like. The first vendor computing device 150a may send a message including the sales details, such as a bill of sale, to the inventory normalization server 120 and, at step 356, the inventory normalization server 120 may, in turn, send the sales details to the user computing device 110.

At step 358, the user computing device 110 may cause the inventory identification application 111 to output, via one or more user interfaces, information indicating the sales details sent from the first vendor computing device 150a. The one or more user interfaces may further output one or more options for receiving payment information from the user and the user may input their payment information. In some cases, the inventory identification application 111 may be linked directly to or integrated with a banking application associated with a banking or credit card account associated with the user. In this way, the user may be able to enter payment details and initiate payment directly through their normal banking application.

At step 360, the user computing device 110 may transmit a payment notification to the inventory normalization server 120 once payment has completed successfully and, the inventory normalization server 120 may notify the first vendor computing device 150a of successful completion of payment.

Accordingly, a user may use the inventory normalization system 100 to identify items similar to a preferred item, receive offers from vendors on one or more of the preferred item or similar items in proximity to the user, receive a recommendation of a best offer based on normalized pricing of offered items in view of the importance to the user of various features included in offered items, and facilitate a purchase of one or more of the offered items.

One or more aspects disclosed herein may be embodied in computer-usable or readable data and/or computer-executable instructions, such as in one or more program modules, executed by one or more computers or other devices as described herein. Generally, program modules include routines, programs, objects, components, data structures, or the like that perform particular tasks or implement particular abstract data types when executed by a processor in a computer or other device. The modules may be written in a source code programming language that is subsequently compiled for execution, or may be written in a scripting language, such as (but not limited to) HTML or XML. The computer-executable instructions may be stored on a computer-readable medium, such as a hard disk, optical disk, removable storage media, solid-state memory, RAM, or the like. As will be appreciated by one of skill in the art, the functionality of the program modules may be combined or distributed as desired in various embodiments. In addition, the functionality may be embodied in whole, or in part, in firmware or hardware equivalents such as integrated circuits, field programmable gate arrays (FPGA), or the like. Particular data structures may be used to more effectively implement one or more aspects disclosed herein, and such data structures are contemplated within the scope of computer-executable instructions and computer-usable data described herein. Various aspects disclosed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method comprising:
receiving, by a first computing device, information identifying a target vehicle;
accessing a web page associated with the information identifying the target vehicle;
performing web-scraping of the web page to extract vehicle features associated with the target vehicle;
normalizing, based on the information identifying the target vehicle and based on a mapping of manufacturer vehicle features to generic vehicles features, the extracted vehicle features;
vectorizing the normalized vehicle features to generate a vectorized list of vehicle features;
identifying, based on detecting a current location, a plurality of vendors within a geographical range of the detected current location;
accessing a plurality of vendor computing devices, corresponding to the plurality of vendors, to identify, based on the vectorized list of vehicle features, one or more similar vehicles having a threshold level of similarity to the target vehicle;
sending, to one or more vendor computing devices of the plurality of vendor computing devices, one or more bid requests for the one or more identified similar vehicles;
receiving, from a first vendor computing device of the one or more vendor computing devices, a first offer for a first similar vehicle of the one or more identified similar vehicles at a first offer price;
generating, based on one or more importance values corresponding to vehicle features associated with the first similar vehicle, a first normalized price associated with the first similar vehicle; and
outputting, to a display associated with the first computing device, the first offer price and the first normalized price.

2. The method of claim 1, wherein the information identifying the target vehicle comprises:
manufacturer identification information; and
a manufacturer build code identifying a user build of a vehicle associated with a manufacturer identified by the manufacturer identification information, and
wherein the method further comprises identifying, based on the manufacturer identification information, the web page associated with the information identifying the target vehicle.

3. The method of claim 1, wherein accessing the plurality of vendor computing devices to identify the one or more similar vehicles having the threshold level of similarity to the target vehicle comprises:
identifying, based on normalizing vehicle features of a plurality of inventory vehicles in an inventory of a vendor associated with a corresponding vendor computing device, one or more inventory vehicles having one or more of the normalized vehicle features of the target vehicle; and
for each of the one or more inventory vehicles having the one or more of the normalized vehicle features of the input vehicle:
generating a similarity score; and
determining that the similarity score satisfies the threshold level of similarity.

4. The method of claim 1, wherein accessing the plurality of vendor computing devices to identify the one or more similar vehicles having the threshold level of similarity to the target vehicle comprises:
receiving information identifying inventory vehicles in inventory at the plurality of vendors;
determining a vectorized list of features for each of the inventory vehicles;
applying a k-means clustering algorithm to a dataset comprising:
a data point corresponding to the target vehicle; and
a plurality of data points corresponding to the inventory vehicles; and
identifying, based on the applying, at least one inventory vehicle having one or more vehicle features similar to the target vehicle.

5. The method of claim 1, further comprising:
receiving, from a second vendor computing device of the one or more vendor computing devices, a second offer for a second similar vehicle, of the one or more identified similar vehicles, at a second offer price;
generating, based on one or more importance values corresponding to vehicle features associated with the second similar vehicle, a second normalized price associated with the second similar vehicle;
comparing the first offer price to the first normalized price and the second offer price to the second normalized price; and
selecting, based on the comparing, the first offer as a recommended offer.

6. The method of claim 1, wherein each of the one or more importance values is associated with a discount factor, and
wherein generating the first normalized price comprises:
determining a first normalized vehicle feature of the target vehicle not included in vehicle features associated with the first similar vehicle;
determining a discount amount by applying, based on an importance value for the first normalized vehicle feature, the associated discount factor to an amount of the first normalized vehicle feature; and
discounting a base price for the target vehicle by the determined discount amount.

7. The method of claim 1, further comprising:
receiving, by the first computing device, a user input accepting the first offer; and
initiating, by the first computing device, a purchase of the first similar vehicle.

8. A computing device comprising:
one or more processors; and
memory storing computer-readable instructions, that when executed by the one or more processors, cause the computing device to:
receive information identifying a target vehicle;
obtain vehicle features associated with the target vehicle;
normalize, based on the information identifying the target vehicle and based on a mapping of manufacturer vehicle features to generic vehicles features, the obtained vehicle features;
vectorize the normalized vehicle features to generate a vectorized list of vehicle features;
identify, based on detecting a current location, a plurality of vendors within a geographical range of the detected current location;
access a plurality of vendor computing devices, corresponding to the plurality of vendors, to identify, based on the vectorized list of vehicle features, one or more similar vehicles having a threshold level of similarity to the target vehicle;
send, to one or more of the plurality of vendor computing devices, one or more bid requests for the one or more identified similar vehicles;
receive, from a first vendor computing device of the one or more vendor computing devices, a first offer for a first offer price for a first similar vehicle of the one or more identified similar vehicles;
generate, based on one or more importance values corresponding to vehicle features associated with the first similar vehicle, a first normalized price associated with the first similar vehicle; and
output, to a display associated with the computing device, the first offer price and the first normalized price.

9. The computing device of claim 8, wherein the information identifying the target vehicle comprises:
manufacturer identification information; and
a manufacturer build code identifying a user build of a vehicle associated with a manufacturer identified by the manufacturer identification information, and
wherein the instructions, when executed by the one or more processors, cause the computing device to identify, based on the manufacturer identification information, a web page associated with the information identifying the target vehicle.

10. The computing device of claim 8, wherein the instructions, when executed by the one or more processors, cause the computing device to access the plurality of vendor computing devices to identify the one or more similar vehicles having the threshold level of similarity to the target vehicle by causing the computing device to:
identify, based on normalizing vehicle features of a plurality of inventory vehicles in an inventory of a vendor associated with a corresponding vendor computing device, one or more inventory vehicles having one or more of the normalized vehicle features of the input vehicle;
for each of the one or more inventory vehicles having the one or more of the normalized vehicle features of the input vehicle:
generate a similarity score; and
determine that the similarity score satisfies the threshold level of similarity.

11. The computing device of claim 8, wherein the instructions, when executed by the one or more processors, cause the computing device to access the plurality of vendor computing devices to identify the one or more similar vehicles having the threshold level of similarity to the target vehicle by causing the computing device to:
receive information identifying inventory vehicles in inventory at the plurality of vendors;
determine a vectorized list of features for each of the inventory vehicles;
apply a k-means clustering algorithm to a dataset comprising:
a data point corresponding to the target vehicle; and
a plurality of data points corresponding to the inventory vehicles; and
identify, based on the applying, at least one inventory vehicle having one or more vehicle features similar to the target vehicle.

12. The computing device of claim 8, wherein the instructions, when executed by the one or more processors, further cause the computing device to:
receive, from a second vendor computing device of the one or more vendor computing devices, a second offer for a second similar vehicle, of the one or more identified similar vehicles, at a second offer price;
generate, based on one or more importance values corresponding to vehicle features associated with the second similar vehicle, a second normalized price associated with the second similar vehicle; and
select, based on comparing the first offer price to the first normalized price and comparing the second offer price to the second normalized price, the first offer as a recommended offer.

13. The computing device of claim 8, wherein each of the one or more importance values is associated with a discount factor, and
wherein the instructions, when executed by the one or more processors, cause the computing device to generate the first normalized price by causing the computing device to:
determine a first normalized vehicle feature of the target vehicle not included in vehicle features associated with the first similar vehicle;
determine a discount amount by applying, based on an importance value for the first normalized vehicle feature, the associated discount factor to an amount of the first normalized vehicle feature; and
discount a base price for the target vehicle by the determined discount amount.

14. The computing device of claim 8, further comprising:
receive a user input accepting the first offer; and
initiate a purchase of the first similar vehicle.

15. A non-transitory, computer-readable medium storing instructions that, when executed by one or more processors, cause a computing device to:
receive an image;
determine, based on analyzing the image using computer vision techniques, information identifying a target item;
obtain, based on the information identifying the target item, features associated with the target item;
normalize, based on the information identifying the target item and based on a mapping of manufacturer features to generic features, the obtained features;
vectorize the normalized features to generate a vectorized list of features;
determine one or more importance values for one or more of the features included in the vectorized list of features;
determine, by applying a clustering algorithm to a dataset comprising data points representing the target item and a plurality of other items, items similar to the target item;
identify, based on detecting a current location, a plurality of vendors within a geographical range of the detected current location;
determine, based on accessing a plurality of vendor computing devices corresponding to the plurality of vendors, a first vendor having one or more of the determined similar items;
send, to one or more vendor computing devices of the plurality of vendor computing devices, one or more requests for offers for the one or more determined similar items;
receive, from a first vendor computing device of the one or more vendor computing devices, a first offer for a first similar item of the one or more determined similar items at a first offer price;
receive, from a second vendor computing device of the one or more vendor computing devices, a second offer for a second similar item of the one or more determined similar items at a second offer price;
generate, based on one or more importance values, a first normalized price associated with the first similar item and a second normalized price associated with the second similar item; and
output, to a display associated with the computing device and based on the first offer price, the second offer price, the first normalized price, and the second normalized price, a recommended offer of the first offer and second offer.

16. The non-transitory, computer-readable medium of claim 15, wherein the instructions, when executed by the one or more processors, cause the computing device to determine, by applying a clustering algorithm to a dataset comprising data points representing the target item and a plurality of other items, the items similar to the target item by causing the computing device to:
distribute each of the data points in the data set into a plurality of clusters, wherein each cluster of the plurality of clusters comprises a centroid; and
determine, based on applying the clustering algorithm, the items similar to the target item as data points within the dataset that are within a predetermined Euclidean distance from a centroid of the plurality of clusters.

17. The non-transitory, computer-readable medium of claim 15, wherein the instructions, when executed by the one or more processors, cause the computing device to determine the plurality of other items by causing the computing device to:
retrieve, from a database, a plurality of stored items of a same type as the target item and a corresponding vectorized list of features for each of the plurality of stored items;
for each of the plurality of stored items:
compare the corresponding vectorized list of features for the stored item to the vectorized list of features for the target item;
generate, based on the comparison, a similarity score for the stored item; and
select, based on a determination that the similarity score for the stored item satisfies a threshold level of similarity, the stored item as one of the plurality of other items.

18. The non-transitory, computer-readable medium of claim 15, wherein each of the one or more importance values is associated with a discount factor, and
wherein the instructions, when executed by the one or more processors, cause the computing device to generate the first normalized price by causing the computing device to:
determine a first normalized feature of the target item not included in features associated with the first similar item;
determine a discount amount by applying, based on an importance value for the first normalized feature, the associated discount factor to an amount of the first normalized feature; and
discount a base price for the target item by the determined discount amount.

19. The non-transitory, computer-readable medium of claim 15, wherein the instructions, when executed by the one or more processors, further cause the computing device to:
output, based on the first offer price, the second offer price, the first normalized price, and the second normalized price, a recommendation of one of the first offer and the second offer.

20. The non-transitory, computer-readable medium of claim 15, wherein the instructions, when executed by the one or more processors, cause the computing device to:
receive a user input accepting the first offer; and
cause payment information to be transmitted to the first vendor computing device.
